(19) United States
(12) Patent Application Publication
(10) Pub. No.: US 2013/0118681 A1
(43) Pub. Date: May 16, 2013

(54) FABRICATING METHOD FOR ELECTRONIC CARD

(71) Applicants: Lee-Chung Lin, New Taipei City (TW); Chi-Yuan Ou, New Taipei City (TW)

(72) Inventors: Lee-Chung Lin, New Taipei City (TW); Chi-Yuan Ou, New Taipei City (TW)

(21) Appl. No.: 13/297,781

(22) Filed: Nov. 16, 2011

(51) Int. Cl. B32B 38/10; B32B 37/14

(52) U.S. Cl. 156/249

(57) ABSTRACT

A fabricating method for electronic card is to interpose an electronic element between an adhesive first outer layer and a non-adhesive detachable pressing plate. The fabricating method comprises following steps. Deposit a first outer layer on a worktable. Embed an electronic element in the first outer layer. Enclose the electronic element by adhesive stuff layer(s). Press foregoing all components via a detachable pressing plate, a quasi-finished laminate is formed with thickness being in preset range. Remove the pressing plate off to form a semi-finished laminate after solidification of the adhesive stuff layer(s). Deposit a second outer layer with a sticky plane over the semi-finished laminate. Apply pressing process on the second outer layer and semi-finished laminate to form a finished laminate due to solidification of the sticky plane on the second outer layer. Finally cut the finished laminate into single electronic cards.

### BACKGROUND OF THE INVENTION

a) Field of the Invention

A fabricating method for electronic card is to embed an electronic element between an adhesive first outer layer with adhesive stuff layer(s) and a non-adhesive detachable pressing plate. Via pressing process, a quasi-finished laminate is formed with thickness being in preset range. Remove the pressing plate off to form a semi-finished laminate after solidification of the adhesive stuff layer(s). Deposit and press a second outer layer on the semi-finished laminate to form a finished laminate. Cut the finished laminate into single electronic cards.

b) Description of the Prior Art

Following the progress of science and technology, various functional requirements for electronic card used in network shopping, network financial transactions, electronic commercial activities and the like become more complicated. Accordingly, financial fraud and stealing abuse criminal involving electronic card considerably increased. Currently, a new smart card of electronic card, which is also known as intelligent card, with keypad and display is introduced for increasing security concern. The smart card offers user capabilities for verification and confirmation via equipped keypad and display during transaction to improve security. The key process in fabricating the foregoing smart electronic card is to embed a printed circuit board (PCB) serving as control processing unit into the smart electronic card. Then, the smart electronic card can be subsequently packaged for finishing the fabricating process after having the PCB embedded into therein. The conventional fabricating process for the traditional electronic card mainly comprises following steps: firstly, prepare a plastic card body and embed an electronic element into the plastic card body; secondly, prepare some wrapping membranes made of PVC (Polyvinyl chloride), PET (Polyethylene Terephthalate), PC (Polycarbonate) thermoplastic substance or metal, then enclose and stick a wrapping membrane over each obverse side and reverse side of the plastic card body; and finally, integrate the wrapping membranes with the plastic card body by proper means in accordance with the feature of the wrapping membrane; For example, if the wrapping membrane is made of thermoplastic substance, a heating fusion can be suitably applied.

However, there are two uncontrollable drawbacks incurred in the forgoing conventional fabricating process, which are inaccurate thickness of the plastic card body and imprecise positioning for the embedding process of the electronic element. Because more electronics are included in the electronic element due to more complicated functional requirement, or additional radio frequency (RF) antenna, the plastic card body may become too thick without desirable accurate thickness. Moreover, because no positioning aid is included in the forgoing conventional fabricating process, a desirable precise positioning for the embedding process of the electronic element can not be definitely obtained. Both of the drawbacks aforesaid will not only damage the quality and yield of fabricating process but also incur extra labor hour in quality control and extra expense in overall manufacturing cost. Besides, the wrapping membrane can easily detach off the plastic card body after having used for certain period. So far, no feasible solution for three drawbacks aforesaid in the forgoing conventional fabricating process is worked out in the electronic card industry. Accordingly, an innovative electronic card with capability being able to solve both drawbacks aforesaid in the forgoing conventional fabricating process becomes an urgent essentiality for the electronic card industry.

### SUMMARY OF THE INVENTION

The primary object of the present invention is to provide a fabricating method for electronic card with key concept that interpose an electronic element between two solid planiform outer layers to form a sandwich-like electronic card. Therefore, the basic procedure of the fabricating method comprising following processing steps: firstly, deposit at least an electronic element between a first outer layer a detachable pressing plate; secondly, enclose the electronic element(s) by an adhesive stuff layer; thirdly, apply pressing process such that overall thickness from first outer layer to pressing plate reaches preset range, then a quasi-finished laminate is formed via adhesive stuff solidification; fourthly, remove the pressing plate off the quasi-finished laminate so that a semi-finished laminate is created; fifthly, deposit a second outer layer with a sticky plane over the semi-finished laminate; and finally, apply pressing process on second outer layer and semi-finished laminate, a finished laminate is formed due to solidification of the adhesive stuff layer with the sticky plane of the second outer layer, and cut the finished laminate into single electronic cards to achieve the purpose in accurately controlling the thickness of the electronic card.

The minor object of the present invention is to provide a fabricating method for electronic card with basic procedure of the fabricating method as following. Firstly, embed an electronic element into an alignment carrier, next situate the alignment carrier with the electronic element therein on a first outer layer in precisely positioning manner, and then enclose the electronic element(s) by an adhesive stuff layer, subsequently, deposit, press and remove a detachable pressing plate, as well as deposit and press a second outer layer to fabricate electronic card(s) within preset position without deviation.

In order to accomplish foregoing objects, the fabricating method for electronic card in the present invention comprises following steps. Deposit an adhesive stuff layer on a first outer layer. Embed at least an electronic element in the adhesive stuff layer and deposit another adhesive stuff layer on the electronic element. Deposit a detachable pressing plate with a non-sticky surface over the adhesive stuff layer such that the non-sticky surface faces towards the first outer layer and apply pressing process such that overall thickness from first outer layer to pressing plate reaches preset range, then a quasi-finished laminate is formed via adhesive stuff solidification. Remove the pressing plate off the quasi-finished laminate so that a semi-finished laminate is created. Deposit a second outer layer with a sticky plane over the semi-finished laminate and apply pressing process on second outer layer and semi-finished laminate, then a finished laminate is formed due to binding solidification of the adhesive stuff layer with the sticky plane of the second outer layer, then cut the finished laminate into single electronic cards.

In foregoing embodiments, the processing steps for first outer layer and detachable pressing plate can be adjustably shifted in accordance with different conditions. For example, firstly, put the detachable pressing plate on a worktable; secondly, form a sandwich intermediate including at least an electronic element with one or two adhesive stuff layer(s); thirdly, sandwich the sandwich intermediate between a first outer layer and detachable pressing plate for pressing process to reach preset thickness; fourthly, form a quasi-finished laminate after solidification of the adhesive stuff layer(s); and finally, remove the detachable pressing plate from the quasi-finished laminate to create a semi-finished laminate. In a preferred embodiment, the pressing process steps for second outer layer and semi-finished laminate can be adjustably shifted in accordance with different environmental conditions. For example, firstly, place the semi-finished laminate on a worktable such that adhesive stuff layer thereof faces upwardly; secondly, stack the second outer layer with a sticky plane on the semi-finished laminate such that the sticky plane of the second outer layer faces downwardly to contact and combine with the semi-finished laminate; and finally, perform pressing process. In another preferred embodiment, foregoing pressing process steps for second outer layer and semi-finished laminate can be adapted as that firstly, invert and place the second outer layer with a sticky plane on the worktable such that the sticky plane of the second outer layer faces upwardly; and secondly, invert and stack the semi-finished laminate over the sticky plane of the second outer layer for performing subsequent pressing process.

In summary of the foregoing descriptions, the key concept of the fabricating method for electronic card in the present invention is that at least an electronic element is embedded between a first outer layer and/or a second outer layer like sandwich manner to form a planiform sandwich intermediate, then via combining the sandwich intermediate with a detachable pressing plate perform pressing process to form an enclosed quasi-finished laminate. The fabricating method for electronic card comprises following processing steps. Enclose a first outer layer (or detachable pressing plate) and electronic element(s) by one or two adhesive stuff layer(s). Deposit a detachable pressing plate (or first outer layer) over the adhesive stuff layer, and apply pressing process such that overall thickness from first outer layer to pressing plate reaches preset range, then a quasi-finished laminate is formed via adhesive stuff solidification, and then remove the pressing plate off the quasi-finished laminate so that a semi-finished laminate is created. Deposit a second outer layer with a sticky plane over the semi-finished laminate, and apply pressing process on second outer layer and semi-finished laminate, and then a finished laminate is formed due to binding solidification of the adhesive stuff layer with the sticky plane of the second outer layer. Finally cut the finished laminate into single electronic cards. By means of the adhesive stuff layer(s) with twice pressing processes, the electronic card body fabricated by the present invention is firmly bound into an entity manner without drawback that the wrapping membrane can easily detach off the plastic card body incurred in the forgoing conventional fabricating process. Thus, the fabricating method of the present invention not only can obtain better profitability due to decrease of the overall manufacturing cost but also can enhance processing feasibility with better yield and quality.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is an illustrative flowchart showing processing steps for the first preferred exemplary embodiment of the present invention.

FIG. 2 is an assembled lateral view showing integration of adhesive stuff layer and first outer layer for the first preferred exemplary embodiment of the present invention.

FIG. 3 is a top view of the previous FIG. 2.

FIG. 4 is an illustrative view showing depositing process of detachable pressing plate over the first work-in-process in previous FIG. 2 for the first preferred exemplary embodiment of the present invention.

FIG. 5 is an illustrative view showing pressing process on the first work-in-process assembled in previous processing steps for the first preferred exemplary embodiment of the present invention.

FIG. 6 is an illustrative lateral view showing quasi-finished laminate for the first preferred exemplary embodiment of the present invention.

FIG. 7 is an illustrative lateral view showing semi-finished laminate after removing the detachable pressing plate from the quasi-finished laminate for the first preferred exemplary embodiment of the present invention.

FIG. 8 is an assembled view showing integrating process of the semi-finished laminate and second outer layer for the first preferred exemplary embodiment of the present invention.

FIG. 9 is an illustrative view showing pressing process of the second outer layer and semi-finished laminate for the first preferred exemplary embodiment of the present invention.

FIG. 10 is an illustrative view showing fabricating finished laminate for the first preferred exemplary embodiment of the present invention.

FIG. 11 is an illustrative view showing positioning process of electronic element facilitated by an alignment carrier for the first preferred exemplary embodiment of the present invention.

FIG. 12 is an illustrative view showing depositing process of detachable pressing plate over the second work-in-process in previous FIG. 11 for the first preferred exemplary embodiment of the present invention.

FIG. 13 is an illustrative flowchart showing processing steps for the second preferred exemplary embodiment of the present invention.

FIG. 14 is an illustrative view showing depositing process of detachable pressing plate over the first work-in-process assembled in previous processing steps for the second preferred exemplary embodiment of the present invention.

FIG. 15 is an illustrative view showing pressing process on the first work-in-process assembled in previous processing steps for the second preferred exemplary embodiment of the present invention.

FIG. 16 is an illustrative flowchart showing processing steps for the third preferred exemplary embodiment of the present invention.

FIG. 17 is an illustrative view showing depositing process of detachable pressing plate over the first work-in-process assembled in previous processing steps for the third preferred exemplary embodiment of the present invention.

FIG. 18 is an illustrative view showing pressing process on the first work-in-process assembled in previous processing steps for the third preferred exemplary embodiment of the present invention.

FIG. 19 is an illustrative view showing integrating process of the semi-finished laminate and first outer layer for the fourth preferred exemplary embodiment of the present invention.

FIG. 20 is an illustrative lateral view showing quasi-finished laminate after depositing process of first outer layer for the fourth preferred exemplary embodiment of the present invention.

FIG. 21 is an illustrative lateral view showing semi-finished laminate after processing and removing the detachable pressing plate from the quasi-finished laminate in previous FIG. 20 for the fourth preferred exemplary embodiment of the present invention.

FIG. 22 is an illustrative lateral view showing stacking process of inverted second outer layer and semi-finished laminate in previous FIG. 21 for the fourth preferred exemplary embodiment of the present invention.

### DETAILED DESCRIPTION OF THE PREFERRED EMBODIMENTS

For facilitating your honorable examiners to have better clearly and definitely profound understanding structure, application and features of the present invention, some preferred exemplary embodiments are disclosed in detailed manner below with associated drawings.

The present invention is a fabricating method for electronic card. The main concept is that multiple card laminates of large area are firstly fabricated on a worktable 1 simultaneously, then cut each card laminate into single pieces of predetermined dimensional size. The fabricating method can be analyzed into following key steps: firstly, bond a first outer layer and electronic elements into an integral quasi-finished laminate; secondly, via depositing, pressing and removing a detachable pressing plate, transform the quasi-finished laminate into a semi-finished laminate; thirdly, via depositing and pressing a second outer layer, transform the semi-finished laminate into a finished laminate; and finally, cut the finished laminate into single electronic cards.

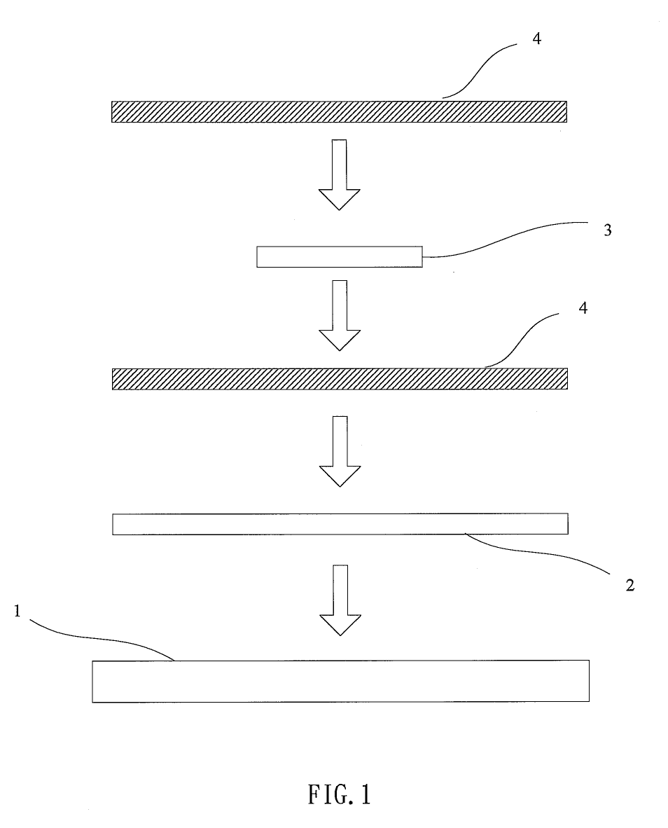

Please refer to FIGS. 1 through 10. In order to achieve foregoing objects, the fabricating method for electronic card in the present invention comprises following steps:

(a) Deposit a first adhesive stuff layer on a first outer layer;

(b) Embed at least an electronic element in the first adhesive stuff layer;

(c) Deposit another second adhesive stuff layer on the electronic elements;

(d) Deposit a detachable pressing plate with a non-sticky surface over the adhesive stuff layer such that the non-sticky surface thereof faces towards the first outer layer;

(e) Apply pressing process on foregoing all components to form a quasi-finished laminate with thickness being in preset range after solidification of the adhesive stuff layers;

(f) Remove the detachable pressing plate off the quasi-finished laminate so that a semi-finished laminate with top and bottom adhesive stuff layers is created;

(g) Deposit a second outer layer with a sticky plane over the semi-finished laminate such that the sticky plane thereof contacts and combines with top adhesive stuff layer of the semi-finished laminate; and

(h) Apply pressing process on second outer layer and semi-finished laminate, a finished laminate is formed due to solidification of the contacting top adhesive stuff layer with the sticky plane of the second outer layer; and cut the finished laminate into single electronic cards.

Further detailed disclose foregoing processing steps are provided as below.

Please refer to FIGS. 1 through 3, which show processing steps of a in an illustrative flowchart for the first preferred exemplary embodiment of electronic card fabricating method in the present invention. The basic components of the fabricating method comprise a first outer layer 2, two adhesive stuff layers 4, an electronic element 3 and a second outer layer 8, wherein:

Said first outer layer 2 is a solid planiform, which is preferably made of metal or thermoplastic substance such as PVC, PET, PC, PETG (Polyethylene terephthalate glycol) and the like;

Said adhesive stuff layer 4 is made of sticky substance, whose feature preferably has rapid solidification property;

Said electronic element 3 is a printed circuit board (PCB) having antenna and relevant electronic components pre-made therein; and

Said second outer layer 8 is a solid planiform with a sticky plane 81, which is beforehand coated by sticky substance such as adhesive material or binding agent so that it has property of stickiness.

Besides, for facilitating the fabricating method of the present invention, a worktable 1, a detachable pressing plate 5 and an alignment carrier 10 are provided with functions as below:

Said worktable 1 serves as a fundamental working platform;

Said pressing plate 5, which has a non-sticky surface 51 formed thereon, serves as a controllable means for thickness of a sandwich intermediate; and

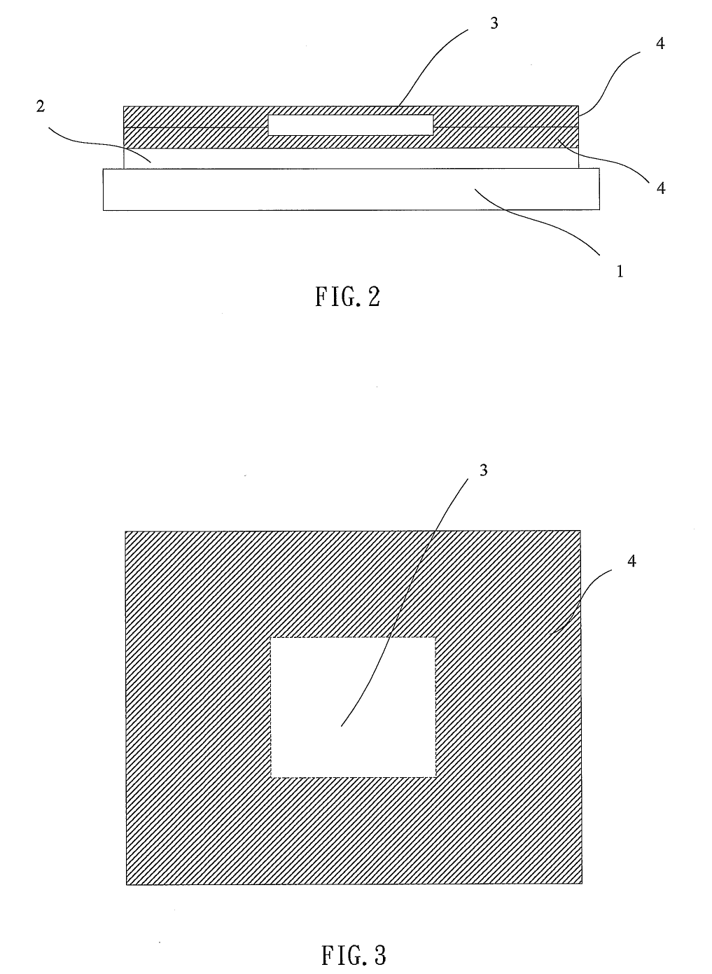

Said alignment carrier 10, which has a holding pit 11 created therein, serves as a positioning aid for precisely embedding the electronic element 3 into the adhesive stuff layer(s) 4;

Wherein, the sandwich intermediate is defined to include at least an electronic element 3 with one or two adhesive stuff layer(s) 4 (as shown in FIG. 2).

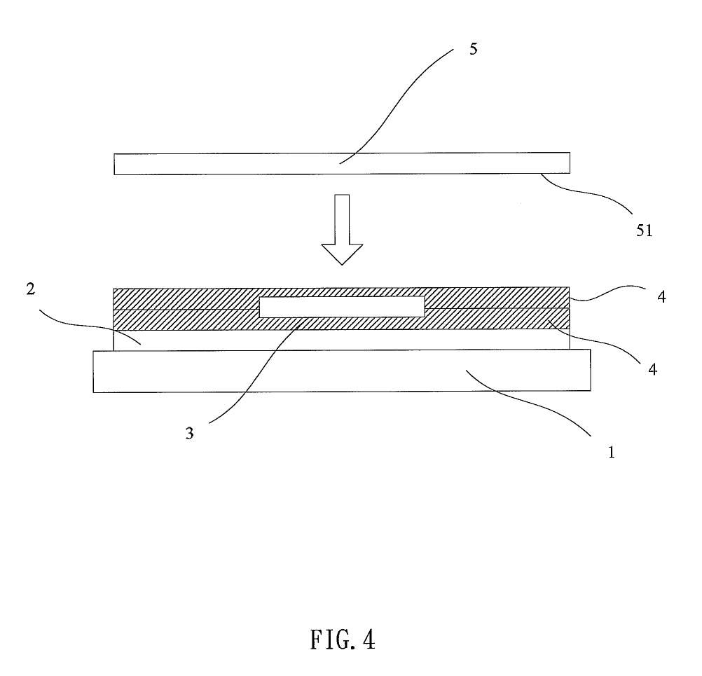

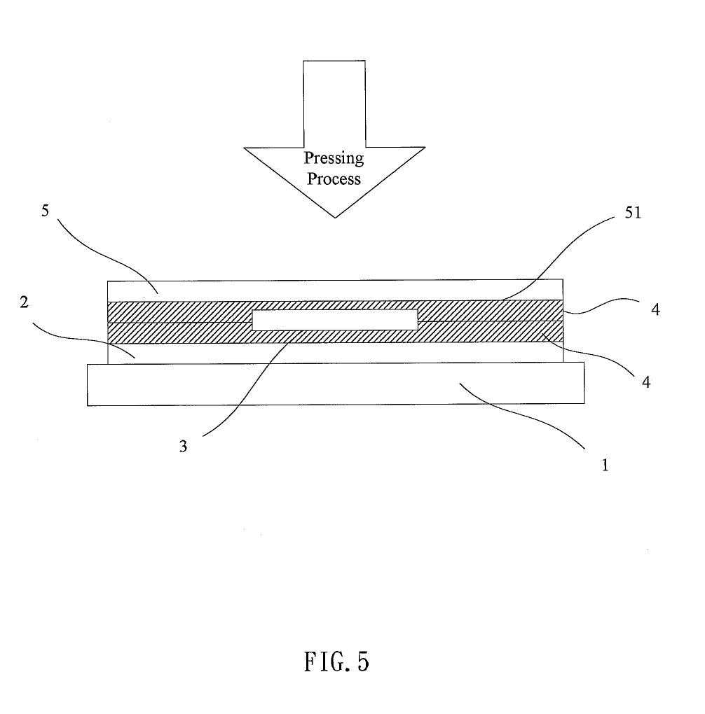

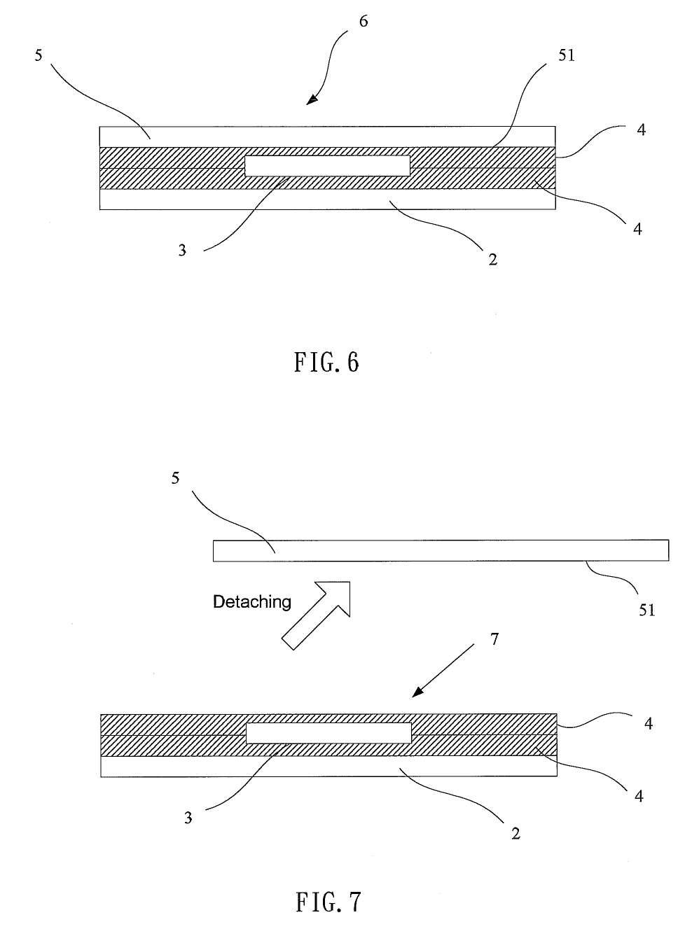

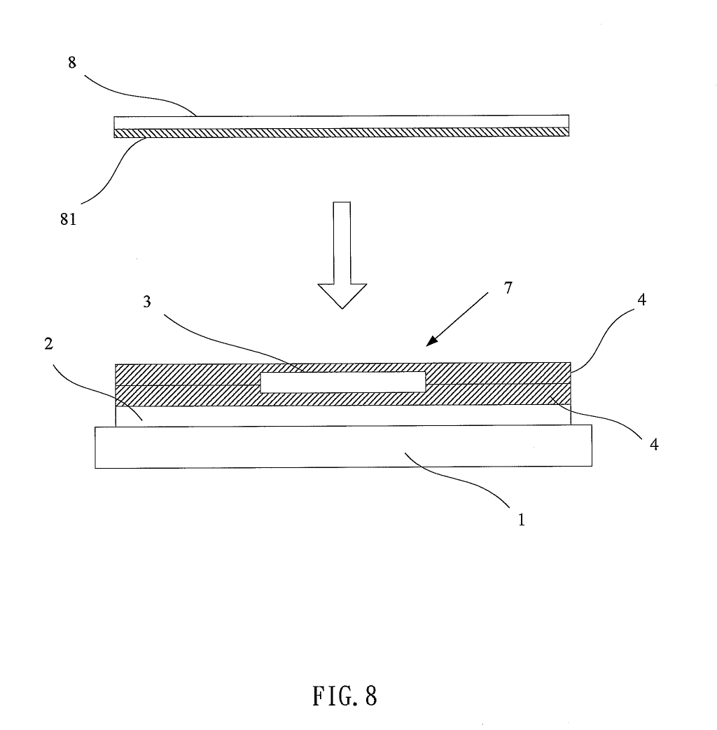

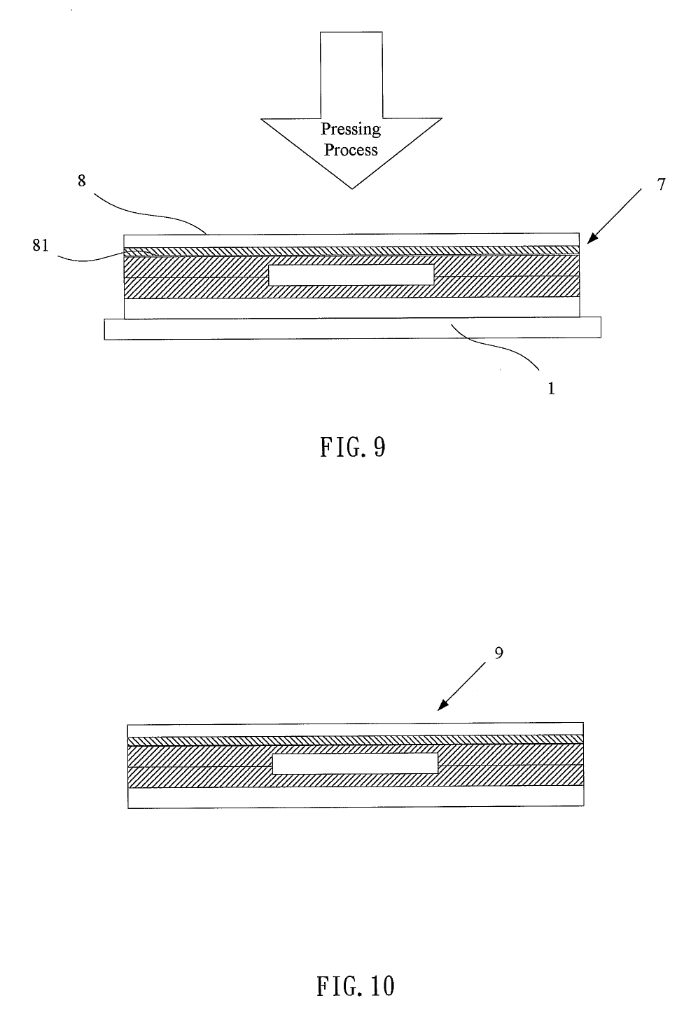

The processing steps of the fabricating method are orderly performed as below. Firstly, prepare a worktable 1 then put the first outer layer 2 on the worktable 1; secondly, deposit a first adhesive stuff layer 4 on the foregoing first outer layer 2; thirdly, embed at least an electronic element 3 in the foregoing adhesive stuff layer 4; fourthly, deposit another second adhesive stuff layer 4 on the foregoing first adhesive stuff layer 4 with embedded electronic elements 3 so that the electronic elements 3 are enclosed by both upper and lower adhesive stuff layers 4 to form a sandwich intermediate as defined above (as shown in FIG. 2); fifthly, by facing the non-sticky surface 51 of the pressing plate 5 towards the foregoing upper adhesive stuff layer 4, deposit the pressing plate 5 over the foregoing upper adhesive stuff layer 4 so that a first work-in-process is assembled (as shown in FIG. 4), wherein the first work-in-process is defined to include a first outer layer 2, a sandwich intermediate and a pressing plate 5 (as shown in FIG. 5); Next, by applying downwards force on the foregoing first work-in-process on the worktable 1 to perform pressing process such that the thickness of the first work-in-process reaches preset range (as shown in FIG. 5); Then, due to rapid solidification property of the adhesive stuff layer 4, the first work-in-process will be quickly bound into a quasi-finished laminate 6 (as shown in FIG. 6); sixthly, remove the pressing plate 5 off the quasi-finished laminate 6 by detaching the non-sticky surface 51 thereof from the upper adhesive stuff layer 4 so that a semi-finished laminate 7 is left as a second work-in-process for subsequent process, wherein the second work-in-process, also the semi-finished laminate 7, is defined to include a first outer layer 2, a sandwich intermediate, but exclude the pressing plate 5 as having been removed (as shown in FIG. 7); seventhly, by facing the sticky plane 81 of the second outer layer 8 towards the upper adhesive stuff layer 4 of the semi-finished laminate 7, deposit the second outer layer 8 on the semi-finished laminate 7 so that a third work-in-process is assembled by the semi-finished laminate 7 and second outer layer 8 (as shown in FIGS. 8 and 9), wherein the third work-in-process is defined to include a first outer layer 2, a sandwich intermediate and a second outer layer 8 (as shown in FIG. 9); Next, by applying downwards force on the foregoing third work-in-process on the worktable 1 to perform pressing process such that the thickness of the third work-in-process reaches preset range (as shown in FIG. 9); Then, due to binding solidification of the adhesive stuff layer 4 with the sticky plane 81 of the second outer layer 8, the third work-in-process will be formed into a finished laminate 9 (as shown in FIG. 10); and finally, cut the finished laminate 9 into pieces of predetermined dimensional size to finish the fabricating process of the electronic card (not shown in the figures).

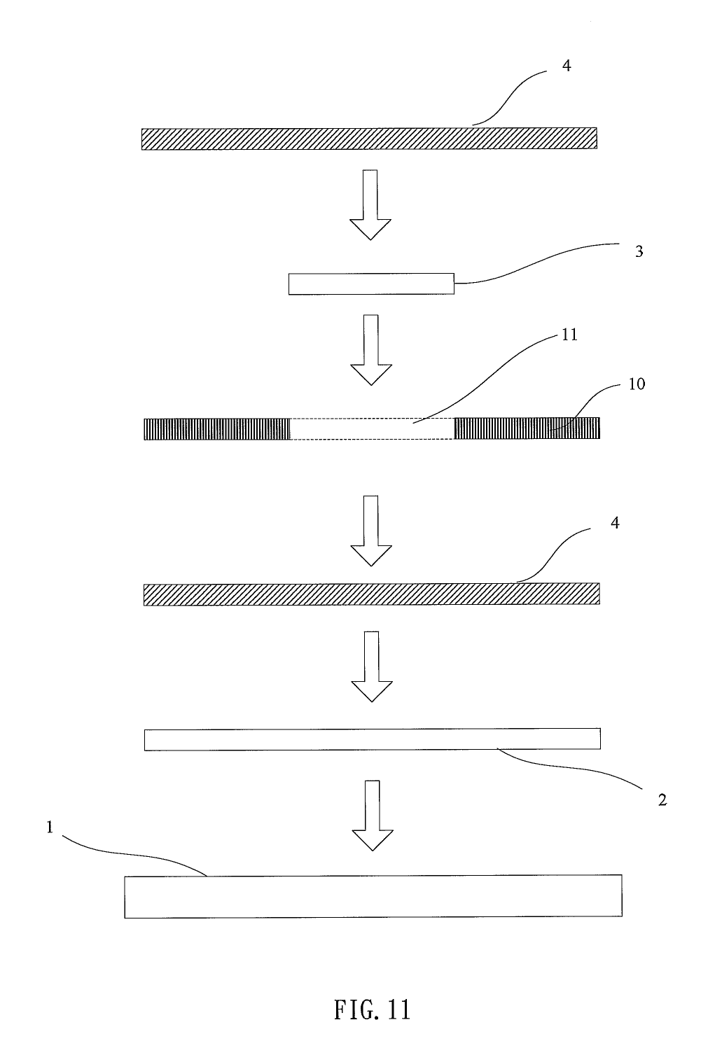

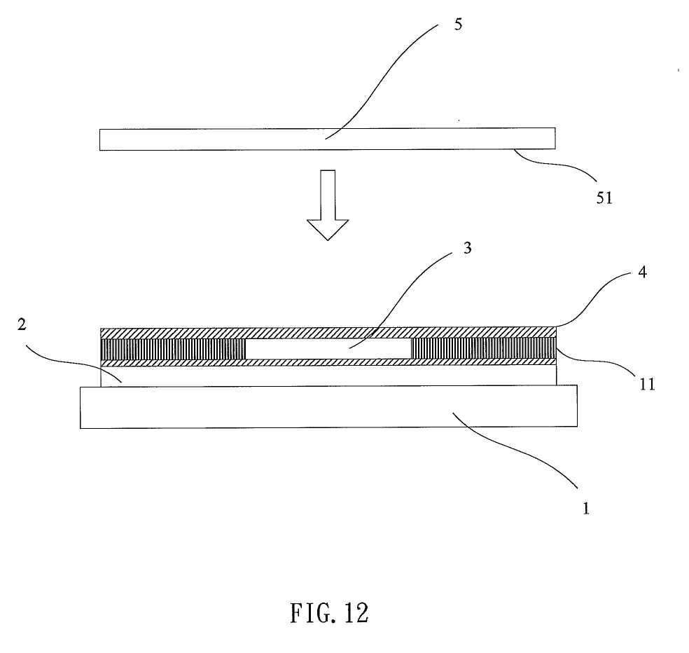

Please refer to FIGS. 11 and 12, which show positioning process of electronic element 3 facilitated by an alignment carrier 10 for the first preferred exemplary embodiment of the present invention. Because no positioning aid is included in the forgoing fabricating process, a desirable precise positioning for embedding the electronic element 3 into the first outer layer 2 or adhesive stuff layer 4 can not be definitely obtained. In order to precisely position the electronic element 3 without deviation, the embedding process thereof can be aided by an alignment carrier 10 with a holding pit 11. In practical operation, the alignment carrier 10 is firstly situated on the first outer layer 2 or adhesive stuff layer 4 in precisely positioning manner; and then embed the electronic element 3 into the holding pit 11 of the alignment carrier 10 so that a desirable precise positioning for the embedding process of the electronic element 3 into the first outer layer 2 or adhesive stuff layer 4 can not be definitely obtained without deviation.

Alternatively, the alignment carrier 10 can be handled with substituted processing steps as below. Firstly, embed the electronic element 3 into the holding pit 11 of the alignment carrier 10; and then situate the alignment carrier 10 with the electronic element 3 therein on the first outer layer 2 or adhesive stuff layer 4 in precisely positioning manner. With this means, not only the electronic element 3 can be precisely positioning but also the yield of the card fabrication can be increased.

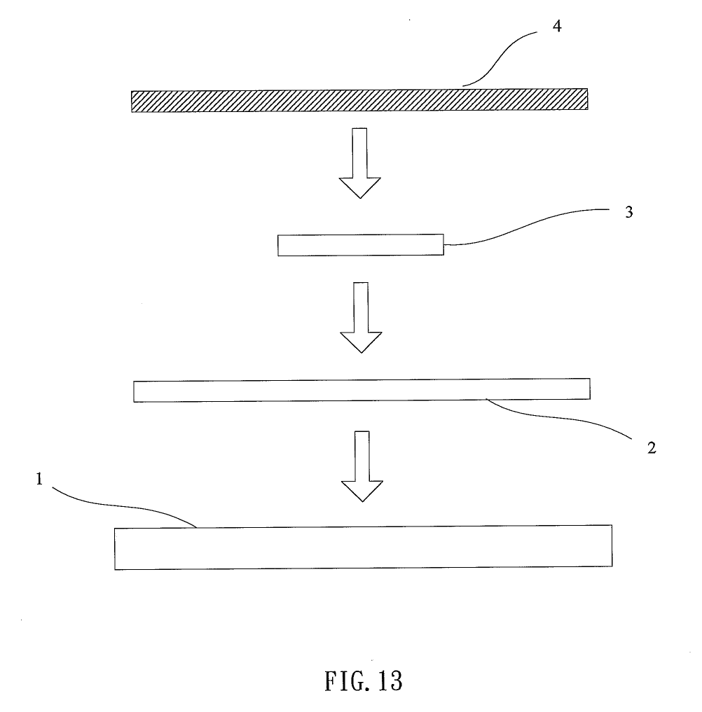

Please refer to FIGS. 13 through 15, which show processing steps for the second preferred exemplary embodiment of the present invention.

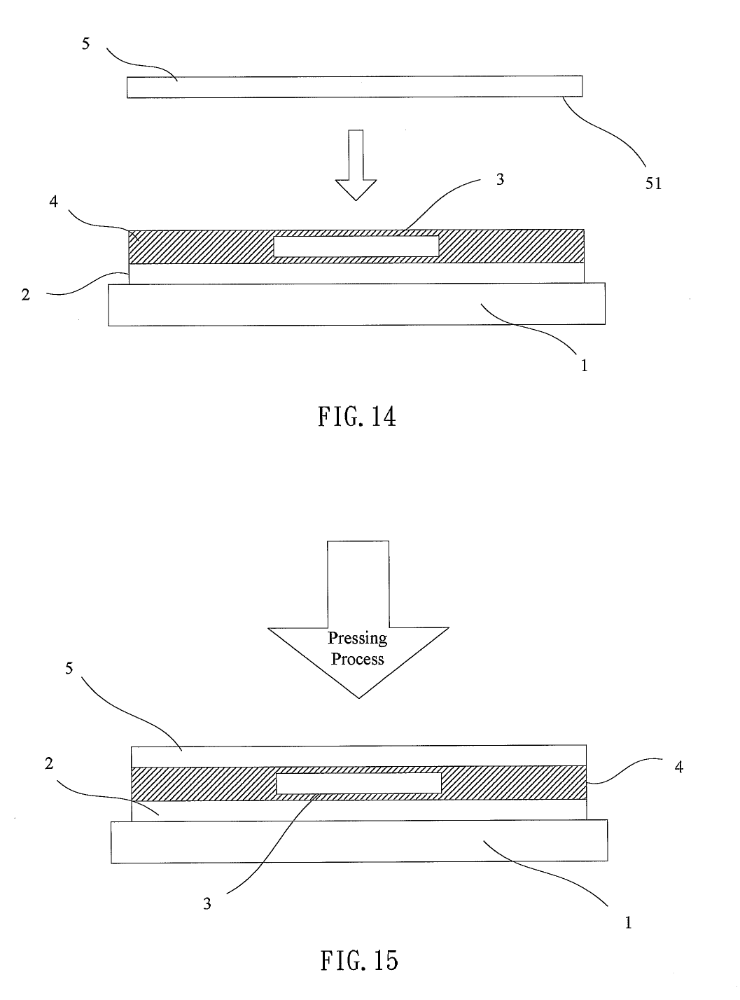

The processing steps of the fabricating method for the second embodiment are orderly performed as below. Firstly, prepare a worktable 1 then put the first outer layer 2 on the worktable 1; secondly, deposit at least an electronic element 3 on the foregoing first outer layer 2; thirdly, deposit an adhesive stuff layer 4 on the foregoing electronic element 3 so that the electronic elements 3 are enclosed by the adhesive stuff layer 4 (as shown in FIG. 14); fourthly, by facing the non-sticky surface 51 of the pressing plate 5 towards the foregoing adhesive stuff layer 4, deposit the pressing plate 5 over the foregoing adhesive stuff layer 4 so that a first work-in-process is assembled (as shown in FIG. 14); Next, by applying downwards force on the foregoing first work-in-process on the worktable 1 to perform pressing process such that the thickness of the first work-in-process reaches preset range (as shown in FIG. 15); Then, due to rapid solidification property of the adhesive stuff layer 4, the first work-in-process will be quickly bound into a quasi-finished laminate 6 (as shown in FIG. 6); fifthly, perform removing process of the pressing plate 5 and integrating process of the second outer layer 8 to obtain a finished laminate 9 (as shown in FIGS. 7 through 10); and finally, cut the finished laminate 9 into pieces of predetermined dimensional size to finish the fabricating process of the electronic card.

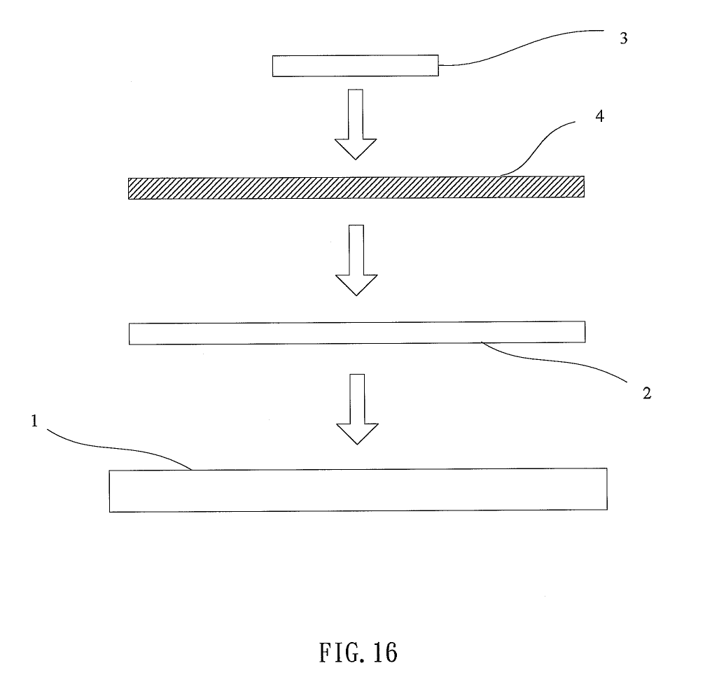

Please refer to FIGS. 16 through 18, which show processing steps for the third preferred exemplary embodiment of the present invention.

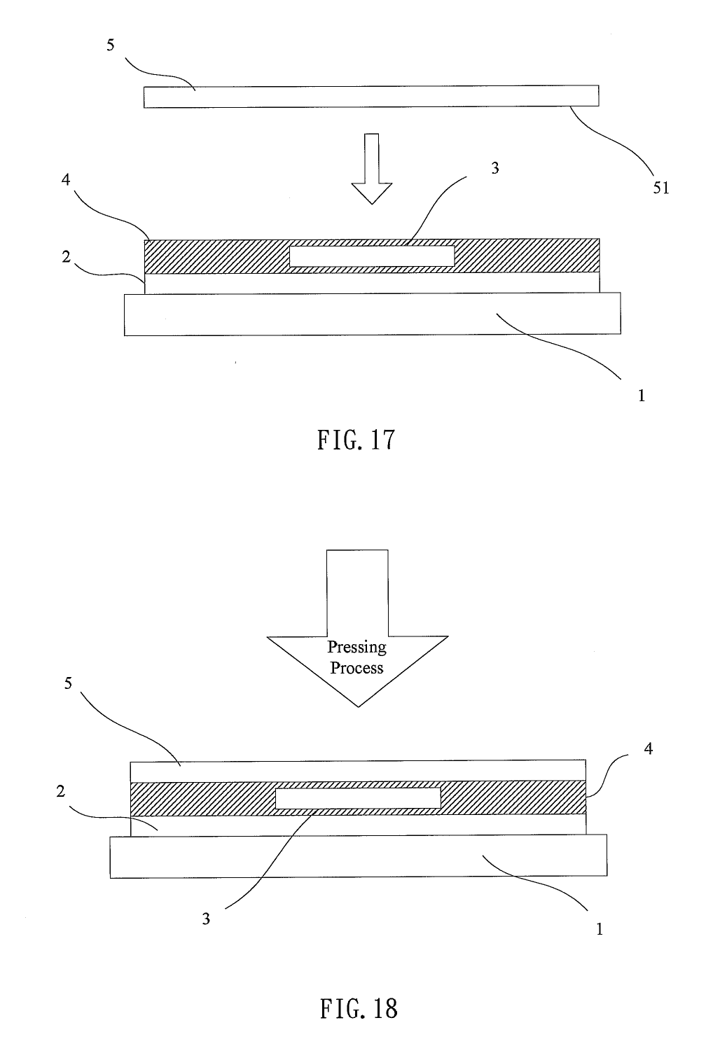

The processing steps of the fabricating method for the third embodiment are orderly performed as below. Firstly, prepare a worktable 1 then put the first outer layer 2 on the worktable 1; secondly, deposit a first adhesive stuff layer 4 on the foregoing first outer layer 2; thirdly, embed at least an electronic element 3 in the foregoing first adhesive stuff layer 4, then deposit another second adhesive stuff layer 4 on the foregoing first adhesive stuff layer 4 with embedded electronic elements 3 so that the electronic element 3 are enclosed by both upper and lower adhesive stuff layers 4; fourthly, by facing the non-sticky surface 51 of the pressing plate 5 towards the foregoing adhesive stuff layer 4, deposit the pressing plate 5 over the foregoing adhesive stuff layer 4 so that a first work-in-process is assembled (as shown in FIG. 17); Next, by applying downwards force on the foregoing first work-in-process on the worktable 1 to perform pressing process such that the thickness of the first work-in-process reaches preset range (as shown in FIG. 18); Then, due to rapid solidification property of the adhesive stuff layer 4, the first work-in-process will be quickly bound into a quasi-finished laminate 6 (as shown in FIG. 6); fifthly, perform removing process of the pressing plate 5 and integrating process of the second outer layer 8 to obtain a finished laminate 9 (as shown in FIGS. 7 through 10); and finally, cut the finished laminate 9 into pieces of predetermined dimensional size to finish the fabricating process of the electronic card.

For the foregoing processing steps of the fabricating method in the second and third embodiments of the present invention, in order to precisely position the electronic element 3 without deviation, the embedding process thereof can be aided by an alignment carrier 10 with a holding pit 11 (as shown in FIGS. 11 and 12). In practical operation, the alignment carrier 10 is firstly situated on the first outer layer 2 or adhesive stuff layer 4; and then embed the electronic element 3 into the holding pit 11 of the alignment carrier 10 so that a desirable precise positioning for embedding the electronic element 3 into the first outer layer 2 or adhesive stuff layer 4 can not be definitely obtained without deviation. Alternatively, firstly, embed the electronic element 3 into the holding pit 11 of the alignment carrier 10; and then situate the alignment carrier 10 with the electronic element 3 therein on the first outer layer 2 or adhesive stuff layer 4. With this means, not only the electronic element 3 can be precisely positioning but also the yield of the card fabrication can be increased.

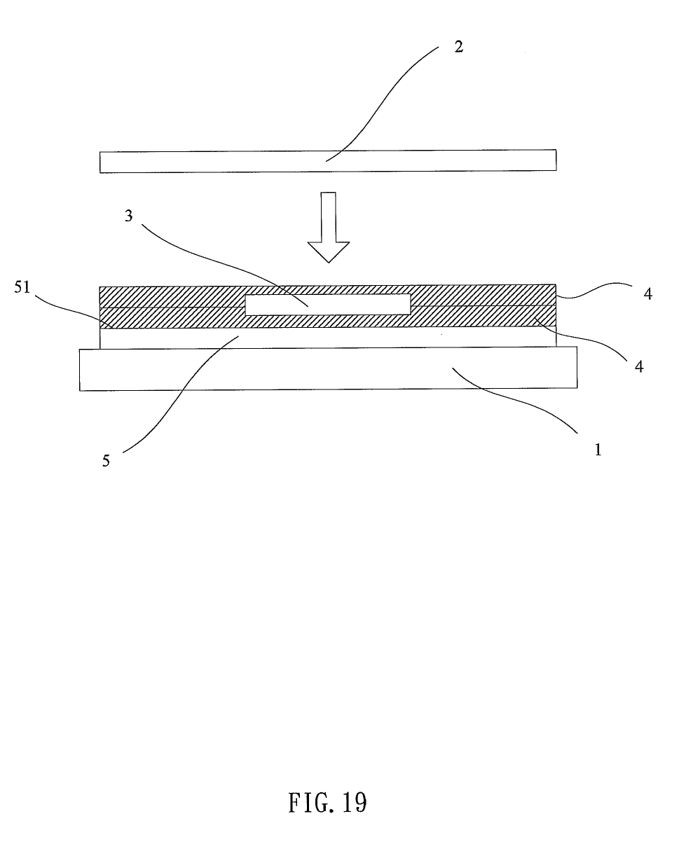

Moreover, in a preferred embodiment, the present invention has an adjustably shifting capability of processing steps for first outer layer 2 and detachable pressing plate 5 processed in previous steps. For example, please refer to FIGS. 19 through 22, which show processing steps for the fourth preferred exemplary embodiment of the present invention.

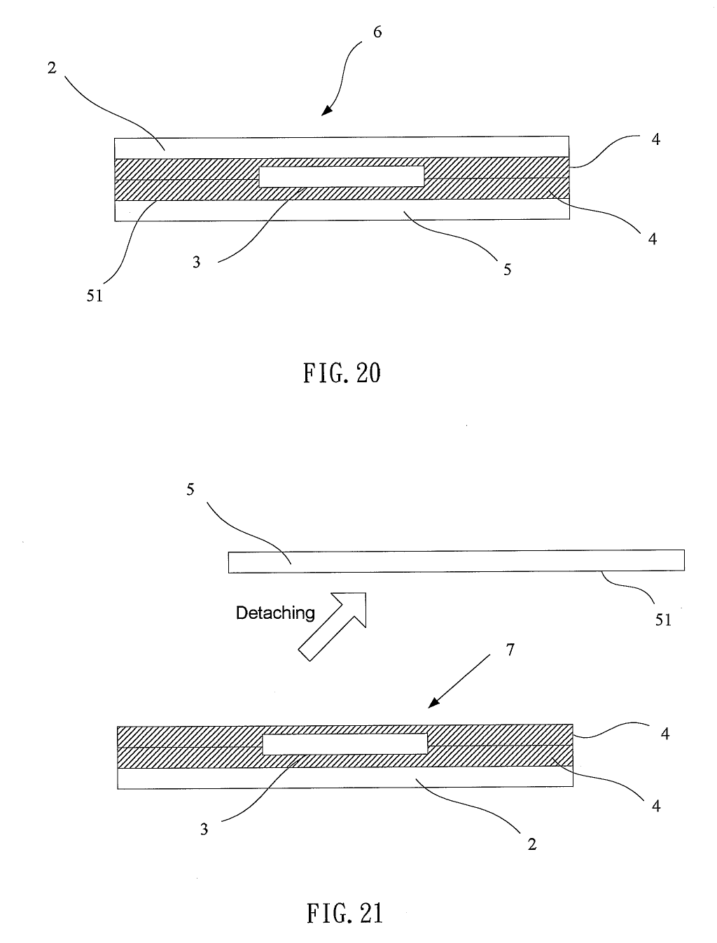

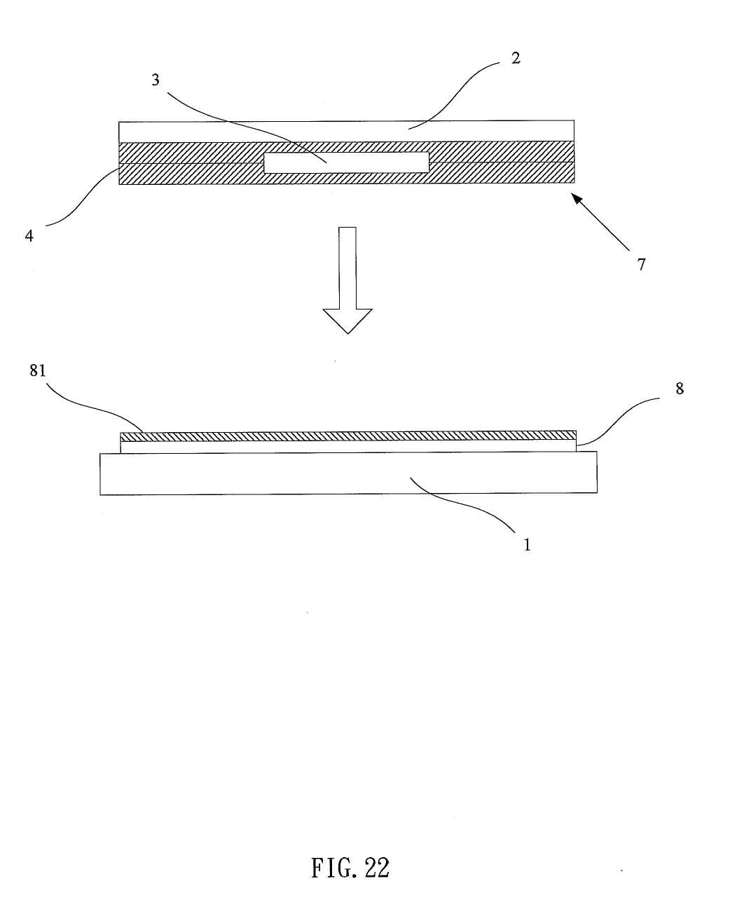

The processing steps of the fabricating method for the fourth embodiment are orderly performed as below. Firstly, prepare a worktable 1, then put the detachable pressing plate 5 with a non-sticky surface 51 on the worktable 1 such that the non-sticky surface 51 facing upwardly; secondly, deposit a first adhesive stuff layer 4 on the foregoing non-sticky surface 51 of the pressing plate 5; thirdly, embed at least an electronic element 3 in the foregoing adhesive stuff layer 4 so that the electronic element 3 is enclosed by the adhesive stuff layers 4; fourthly, deposit another second adhesive stuff layer 4 on the foregoing first adhesive stuff layer 4 with embedded electronic element 3 so that the electronic elements 3 are enclosed by both upper and lower adhesive stuff layers 4 to form a sandwich intermediate as defined above (as shown in FIG. 2); fifthly, put the first outer layer 2 on the foregoing sandwich intermediate to form a planiform quasi-finished laminate 6 (as shown in FIG. 20); sixthly, perform pressing process via a pressing plate 5 over the foregoing quasi-finished laminate 6 to have the thickness thereof reached preset range, and to get a solidified quasi-finished laminate 6 (as shown in FIG. 21); seventhly, perform removing process of the pressing plate 5 to form a planiform semi-finished laminate 7; eighthly, invert and place the second outer layer 8 with a sticky plane 81 on the worktable 1 such that the sticky plane 81 of the second outer layer 8 faces upwardly to perform integrating process of the second outer layer 8 to obtain a finished laminate 9 (as shown in FIG. 22); ninthly, invert and stack the semi-finished laminate 7 over the sticky plane 81 of the second outer layer 8 for performing pressing process to obtain a finished laminate 9; and finally, cut the finished laminate 9 into pieces of predetermined dimensional size to finish the fabricating process of the electronic card.

Please retrospectively refer to FIG. 8, wherein firstly place the semi-finished laminate 7 on the worktable 1, then deposit the second outer layer 8 with a sticky plane 81 over the semi-finished laminate 7, which consists of a first outer layer 2 and an electronic element 3 embedded and sandwiched between two adhesive stuff layers 4, such that the sticky plane 81 of the second outer layer 8 faces downwardly. Subsequently, necessary pressing process is performed. Whereas, for emphasizing the interchangeable feature of processing steps for first outer layer 2 and detachable pressing plate 5 processed in previous steps, please refer to FIG. 22, wherein firstly invert and place the second outer layer 8 with a sticky plane 81 on the worktable 1 such that the sticky plane 81 of the second outer layer 8 faces upwardly, then invert and stack the semi-finished laminate 7 over the sticky plane 81 of the second outer layer 8. Subsequently, necessary pressing process is performed.

In conclusion the disclosure heretofore, the key feature of the fabricating method for electronic card in the present invention is that at least an electronic element 3 is embedded between a first outer layer 2 and/or a second outer layer 8 like sandwich manner to form a planiform sandwich intermediate, then via combining the sandwich intermediate with a detachable pressing plate 5 perform pressing process to form an enclosed quasi-finished laminate 6. Therefore, the processing order for depositing first outer layer 2 and placing detachable pressing plate 5 steps is adjustably shifted in accordance with practically processing status.

Accordingly, the basic processing steps of the processing step adjustably shifted fabricating method are orderly performed as below. Firstly, prepare a worktable 1 then put the detachable pressing plate 5 with a non-sticky surface 51 on the worktable 1 (as shown in FIG. 19); secondly, form a sandwich intermediate, which consists of at least an electronic element 3 embedded and sandwiched between two adhesive stuff layers 4; thirdly, deposit a first outer layer 2 on the foregoing sandwich intermediate to form a quasi-finished laminate 6 after pressing process and solidification of the adhesive stuff layer 4 (as shown in FIG. 20); fourthly, remove the detachable pressing plate 5 via removing process to form a semi-finished laminate 7 (as shown in FIG. 21); fifthly, invert and place the second outer layer 8 with a sticky plane 81 on the worktable 1 to obtain a finished laminate 9 (as shown in FIG. 22); sixthly, invert and stack the semi-finished laminate 7 over second outer layer 8 for performing pressing process to obtain a finished laminate 9; and finally, cut the finished laminate 9 into pieces of predetermined dimensional size to finish the fabricating process of the electronic card.

As mentioned in the previous paragraph “PRIOR ARTS OF THE INVENTION”, there are three uncontrollable drawbacks incurred in the forgoing conventional fabricating process, which are inaccurate thickness of the plastic card body, imprecise positioning for the embedding process of the electronic element and the wrapping membrane can easily detach off the plastic card body after having used for certain period. With the fabricating method for electronic card in the present invention, these three uncontrollable drawbacks can be effectively solved. By means of twice pressing processes, one of which is aided by the detachable pressing plate 5, the thickness of the plastic card body can be accurately controlled to desired range. And by aid of the alignment carrier 10 with a holding pit 11, the positioning for the embedding process of the electronic element 3 can be precisely controlled to satisfactory level. Moreover, by means of the adhesive stuff layer(s) 4 with twice pressing processes, the electronic card body fabricated by the present invention is firmly bound into an entity manner, which solves the drawback of the wrapping membrane can easily detach off the plastic card body incurred in the forgoing conventional fabricating process. Thus, the fabricating method of the present invention not only can obtain better profitability due to decrease of the overall manufacturing cost but also can enhance processing feasibility with better yield and quality.

It is of course to be understood that the embodiments described herein is merely illustrative of the principles of the invention and that a wide variety of modifications thereto may be effected by persons skilled in the art without departing from the spirit and scope of the invention, as set forth in the following claims.

What is claimed is:

1. A fabricating method for electronic card comprising steps of:
(a) depositing a first adhesive stuff layer on a first outer layer;
(b) embedding at least an electronic element in the first adhesive stuff layer;
(c) depositing another second adhesive stuff layer on the electronic elements;
(d) depositing a detachable pressing plate with a non-sticky surface over the second adhesive stuff layer such that the non-sticky surface thereof faces towards the first outer layer;
(e) applying pressing process on foregoing all components to form a quasi-finished laminate with thickness being in preset range after solidification of the adhesive stuff layers;
(f) removing the detachable pressing plate off the quasi-finished laminate so that a semi-finished laminate with top and bottom adhesive stuff layers is created;
(g) depositing a second outer layer with a sticky plane over the semi-finished laminate such that the sticky plane thereof contacts and combines with top adhesive stuff layer of the semi-finished laminate; and
(h) applying pressing process on second outer layer and semi-finished laminate, a finished laminate is formed due to solidification of the contacting top adhesive stuff layer with the sticky plane of the second outer layer; and cut the finished laminate into single electronic cards.

2. The fabricating method for electronic card is recited and claimed in claim 1, wherein step (b) for depositing electronic element, which can be aided by an alignment carrier with revised processing step that the alignment carrier is firstly situated on the adhesive stuff layer in precisely positioning manner, and then embed the electronic element into the alignment carrier.

3. The fabricating method for electronic card is recited and claimed in claim 1, wherein step (b) for depositing electronic element, which can be aided by an alignment carrier with revised processing step that embed the electronic element into an alignment carrier firstly, and then situate the alignment carrier with the electronic element therein on the adhesive stuff layer in precisely positioning manner.

4. The fabricating method for electronic card is recited and claimed in claim 1, wherein step (g) for depositing second outer layer, which can be revised into processing steps that invert and place the second outer layer with a sticky plane on the worktable such that the sticky plane of the second outer layer faces upwardly; and invert and stack the semi-finished laminate over the sticky plane of the second outer layer for contacting combination.

5. A fabricating method for electronic card comprising steps of:
(a) depositing a first adhesive stuff layer on a detachable pressing plate with a non-sticky surface;
(b) embedding at least an electronic element in the first adhesive stuff layer;
(c) depositing another second adhesive stuff layer on the electronic elements;
(d) by facing towards the detachable pressing plate, deposit a first outer layer over the second adhesive stuff layer;
(e) applying pressing process on foregoing all components to form a quasi-finished laminate with thickness being in preset range after solidification of the adhesive stuff layers;
(f) removing the detachable pressing plate off the quasi-finished laminate so that a semi-finished laminate with top and bottom adhesive stuff layers is created;
(g) depositing a second outer layer with a sticky plane over the semi-finished laminate such that the sticky plane thereof contacts and combines with top adhesive stuff layer of the semi-finished laminate; and
(h) applying pressing process on second outer layer and semi-finished laminate, a finished laminate is formed due to solidification of the contacting top adhesive stuff layer with the sticky plane of the second outer layer; and cut the finished laminate into single electronic cards.

6. The fabricating method for electronic card is recited and claimed in claim 5, wherein step (b) for depositing electronic element, which can be aided by an alignment carrier with revised processing step that the alignment carrier is firstly situated on the adhesive stuff layer in precisely positioning manner, and then embed the electronic element into the alignment carrier.

7. The fabricating method for electronic card is recited and claimed in claim 5, wherein step (b) for depositing electronic element, which can be aided by an alignment carrier with revised processing step that embed the electronic element into an alignment carrier firstly, and then situate the alignment carrier with the electronic element therein on the adhesive stuff layer in precisely positioning manner.

8. The fabricating method for electronic card is recited and claimed in claim 5, wherein step (g) for depositing second outer layer, which can be revised into processing steps that invert and place the second outer layer with a sticky plane on the worktable such that the sticky plane of the second outer layer faces upwardly; and invert and stack the semi-finished laminate over the sticky plane of the second outer layer for contacting combination.

9. A fabricating method for electronic card comprising steps of:
(a) depositing at least an electronic element on a first outer layer;
(b) depositing an adhesive stuff layer on the electronic elements;
(c) depositing a detachable pressing plate with a non-sticky surface over the adhesive stuff layer such that the non-sticky surface thereof faces towards the first outer layer;
(d) applying pressing process on foregoing all components to form a quasi-finished laminate with thickness being in preset range after solidification of the adhesive stuff layers;
(e) removing the detachable pressing plate off the quasi-finished laminate so that a semi-finished laminate with adhesive stuff layers is created;
(f) depositing a second outer layer with a sticky plane over the semi-finished laminate such that the sticky plane thereof contacts and combines with adhesive stuff layer of the semi-finished laminate; and
(g) applying pressing process on second outer layer and semi-finished laminate, a finished laminate is formed due to solidification of the contacting adhesive stuff layer with the sticky plane of the second outer layer; and cut the finished laminate into single electronic cards.

10. The fabricating method for electronic card is recited and claimed in claim 9, wherein step (a) for depositing electronic element, which can be aided by an alignment carrier with revised processing step that the alignment carrier is firstly situated on the adhesive stuff layer in precisely positioning manner, and then embed the electronic element into the alignment carrier.

11. The fabricating method for electronic card is recited and claimed in claim 9, wherein step (a) for depositing electronic element, which can be aided by an alignment carrier with revised processing step that embed the electronic element into an alignment carrier firstly, and then situate the alignment carrier with the electronic element therein on the adhesive stuff layer in precisely positioning manner.

12. The fabricating method for electronic card is recited and claimed in claim 9, wherein step (f) for depositing second outer layer, which can be revised into processing steps that invert and place the second outer layer with a sticky plane on the worktable such that the sticky plane of the second outer layer faces upwardly; and invert and stack the semi-finished laminate over the sticky plane of the second outer layer for contacting combination.

13. A fabricating method for electronic card comprising steps of:
(a) depositing at least an electronic element on a detachable pressing plate with a non-sticky surface;
(b) depositing an adhesive stuff layer on the electronic elements;
(c) by facing towards the detachable pressing plate, deposit a first outer layer over the adhesive stuff layer;
(d) applying pressing process on foregoing all components to form a quasi-finished laminate with thickness being in preset range after solidification of the adhesive stuff layers;
(e) removing the detachable pressing plate off the quasi-finished laminate so that a semi-finished laminate with adhesive stuff layers is created;
(f) depositing a second outer layer with a sticky plane over the semi-finished laminate such that the sticky plane thereof contacts and combines with adhesive stuff layer of the semi-finished laminate; and
(g) applying pressing process on second outer layer and semi-finished laminate, a finished laminate is formed due to solidification of the contacting adhesive stuff layer with the sticky plane of the second outer layer; and cut the finished laminate into single electronic cards.

14. The fabricating method for electronic card is recited and claimed in claim 13, wherein step (a) for depositing electronic element, which can be aided by an alignment carrier with revised processing step that the alignment carrier is firstly situated on the adhesive stuff layer in precisely positioning manner, and then embed the electronic element into the alignment carrier.

15. The fabricating method for electronic card is recited and claimed in claim 13, wherein step (a) for depositing electronic element, which can be aided by an alignment carrier with revised processing step that embed the electronic element into an alignment carrier firstly, and then situate the alignment carrier with the electronic element therein on the adhesive stuff layer in precisely positioning manner.

16. The fabricating method for electronic card is recited and claimed in claim 13, wherein step (f) for depositing second outer layer, which can be revised into processing steps that invert and place the second outer layer with a sticky plane on the worktable such that the sticky plane of the second outer layer faces upwardly; and invert and stack the semi-finished laminate over the sticky plane of the second outer layer for contacting combination.

17. A fabricating method for electronic card comprising steps of:
(a) depositing an adhesive stuff layer on a first outer layer;
(b) embedding at least an electronic element in the adhesive stuff layer;
(c) depositing a detachable pressing plate with a non-sticky surface over the adhesive stuff layer such that the non-sticky surface thereof f faces towards the first outer layer;
(d) applying pressing process on foregoing all components to form a quasi-finished laminate with thickness being in preset range after solidification of the adhesive stuff layers;
(e) removing the detachable pressing plate off the quasi-finished laminate so that a semi-finished laminate with adhesive stuff layers is created;
(f) depositing a second outer layer with a sticky plane over the semi-finished laminate such that the sticky plane thereof contacts and combines with adhesive stuff layer of the semi-finished laminate; and
(g) applying pressing process on second outer layer and semi-finished laminate, a finished laminate is formed due to solidification of the contacting adhesive stuff layer with the sticky plane of the second outer layer; and cut the finished laminate into single electronic cards.

18. The fabricating method for electronic card is recited and claimed in claim 17, wherein step (b) for depositing electronic element, which can be aided by an alignment carrier with revised processing step that the alignment carrier is firstly situated on the adhesive stuff layer in precisely positioning manner, and then embed the electronic element into the alignment carrier.

19. The fabricating method for electronic card is recited and claimed in claim 17, wherein step (b) for depositing electronic element, which can be aided by an alignment carrier with revised processing step that embed the electronic element into an alignment carrier firstly, and then situate the alignment carrier with the electronic element therein on the adhesive stuff layer in precisely positioning manner.

20. The fabricating method for electronic card is recited and claimed in claim 17, wherein step (f) for depositing second outer layer, which can be revised into processing steps that invert and place the second outer layer with a sticky plane on the worktable such that the sticky plane of the second outer layer faces upwardly; and invert and stack the semi-finished laminate over the sticky plane of the second outer layer for contacting combination.

21. A fabricating method for electronic card comprising steps of:
(a) depositing an adhesive stuff layer on a detachable pressing plate with a non-sticky surface;
(b) embedding at least an electronic element in the adhesive stuff layer;
(c) by facing towards the detachable pressing plate, deposit a first outer layer over the adhesive stuff layer;
(d) applying pressing process on foregoing all components to form a quasi-finished laminate with thickness being in preset range after solidification of the adhesive stuff layers;
(e) removing the detachable pressing plate off the quasi-finished laminate so that a semi-finished laminate with adhesive stuff layers is created;
(f) depositing a second outer layer with a sticky plane over the semi-finished laminate such that the sticky plane thereof contacts and combines with adhesive stuff layer of the semi-finished laminate; and
(g) applying pressing process on second outer layer and semi-finished laminate, a finished laminate is formed due to solidification of the contacting adhesive stuff layer with the sticky plane of the second outer layer; and cut the finished laminate into single electronic cards.

22. The fabricating method for electronic card is recited and claimed in claim 21, wherein step (b) for depositing electronic element, which can be aided by an alignment carrier with revised processing step that the alignment carrier is firstly situated on the adhesive stuff layer in precisely positioning manner, and then embed the electronic element into the alignment carrier.

23. The fabricating method for electronic card is recited and claimed in claim 21, wherein step (b) for depositing electronic element, which can be aided by an alignment carrier with revised processing step that embed the electronic element into an alignment carrier firstly, and then situate the alignment carrier with the electronic element therein on the adhesive stuff layer in precisely positioning manner.

24. The fabricating method for electronic card is recited and claimed in claim 21, wherein step (f) for depositing second outer layer, which can be revised into processing steps that invert and place the second outer layer with a sticky plane on the worktable such that the sticky plane of the second outer layer faces upwardly; and invert and stack the semi-finished laminate over the sticky plane of the second outer layer for contacting combination.
